(19) United States
(12) Patent Application Publication
(10) Pub. No.: US 2002/0117184 A1
(43) Pub. Date: Aug. 29, 2002

(54) Toothpick with two functional ends

(76) Inventor: Flemming Kragh, Snekkersten (DK)

Correspondence Address: Edwin V. Merkel, NIXON PEABODY LLP, Clinton Square, P.O. Box 31051, Rochester, NY, 14603-1051, US

(21) Appl. No.: 10/074,876

(22) Filed: Feb. 12, 2002

Related U.S. Application Data
(60) Provisional application No. 60/268,163, filed on Feb. 12, 2001.

(51) Int. Cl. A61C 15/00

(52) U.S. Cl. 132/321

(57) ABSTRACT

A toothpick which includes: a unitary body including a blade portion at one end of the body, a claw portion at an opposite end of the body, and a handle portion positioned between the blade portion and the claw portion.

This application claims the priority benefit of U.S. Provisional Patent Application Serial No. 60/268,163, filed Feb. 12, 2001, which is hereby incorporated by reference in its entirety.

### FIELD OF THE INVENTION

The present invention relates generally to implements for dental hygiene and, more specifically, to toothpicks and their use.

### SUMMARY OF THE INVENTION

A first aspect of the present invention relates to a toothpick which includes: a unitary body including a blade portion at one end of the body, a claw portion at an opposite end of the body, and a handle portion positioned between the blade portion and the claw portion.

A second aspect of the present invention relates to a toothpick which includes: a unitary body formed of a thermoplastic material, the body including a blade portion at one end of the body, a claw portion at an opposite end of the body, and a handle portion positioned between the blade portion and the claw portion, wherein the blade portion is elongate and tapered uniformly along substantially the entire length thereof and is sufficiently flexible for bending between a first position and a second position, yet when bent into the second position the blade portion remains substantially set in the second position.

A third aspect of the present invention relates to a toothpick which includes: a unitary body formed of a thermoplastic material, the body including (i) a blade portion at one end of the body, the blade portion being elongate and tapered uniformly along substantially the entire length thereof, having a substantially triangular cross-section along substantially the entire length thereof, and being sufficiently flexible for bending between a first position and a second position, yet when bent into the second position the blade portion remains substantially set in the second position; (ii) a claw portion at an opposite end of the body, the claw portion including an inner arcuate surface, an outer arcuate surface, and tapered lateral sides, where the outer arcuate surface is characterized by a radius which is larger than a radius of the inner arcuate surface; and (iii) a handle portion positioned between the blade portion and the claw portion, the handle portion having opposite sides including shallow depressions which extend substantially the entire length thereof.

Because the toothpicks of the present invention include two functional ends (i.e., the blade portion and the claw portion), the toothpicks are adapted for removing most any type of unwanted food particle lodged between adjacent teeth, between braces or other types of dental work, etc. The blade portion is tapered and so adapted to most gaps between teeth. Moreover, due to its ability to retain its shape when bent, the blade portion is able to access even the gaps between molars. The claw portion can be manipulated to remove stubbornly lodged food particles. These two functional ends can be manipulated by the user by grasping its centrally positioned handle portion; thus, when a user switches the functional ends being employed, an individual need not grasp a region of the toothpick which has already become moistened by saliva.

### BRIEF DESCRIPTION OF THE DRAWINGS

FIG. 1 is a top plan view of a toothpick according to one embodiment of the present invention.

FIG. 2 is a side elevational view of the toothpick shown in FIG. 1.

FIG. 3 is a bottom plan view of the toothpick shown in FIG. 1.

FIGS. 4A-B are cross-sectional views of the blade portion according to lines A-A and B-B shown in FIG. 3. Together, FIGS. 4A-B further illustrate the tapered construction of the blade portion.

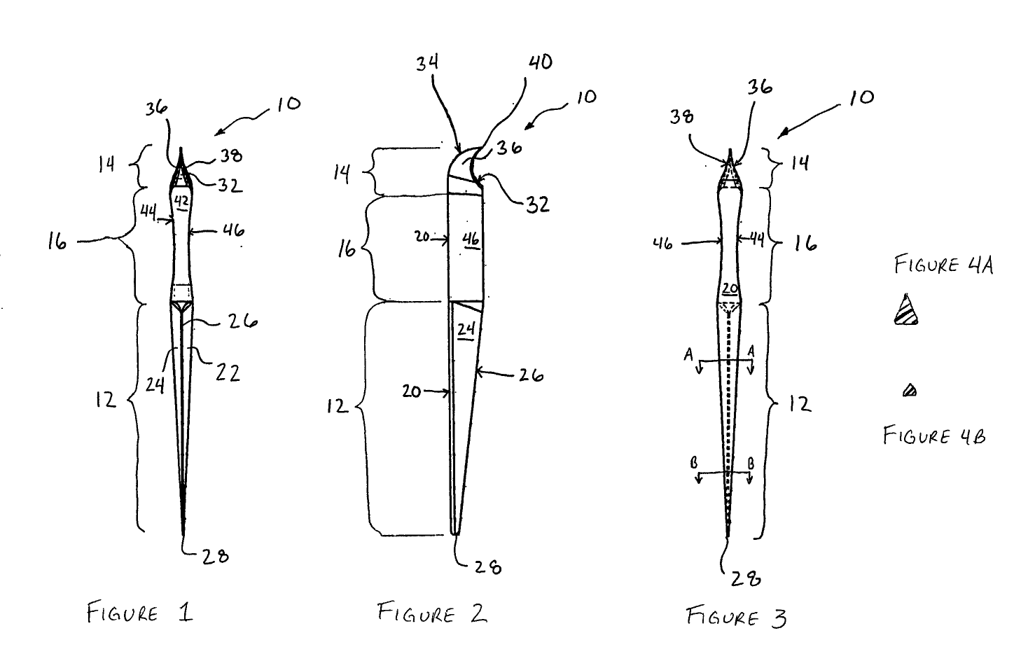

### DETAILED DESCRIPTION OF THE INVENTION

As shown in the accompanying figures, a toothpick according to one embodiment of the present invention is characterized by a unitary body 10 that includes three distinct portions thereof: a blade portion 12 at one end of the body, a claw portion at an opposite end of the body 14, and a handle portion 16 positioned between the blade portion and the claw portion.

Although the unitary body 10 need not be formed of the same material throughout, fabrication thereof is simplified by using a single material. Because the toothpick of the present invention is intended to be used only once or, at most, a few times prior to its disposal, the materials utilized in the construction thereof should be durable for the intended use. The unitary body is preferably formed of a thermoplastic material which is capable of allowing the blade portion thereof to be flexible yet substantially retain its position when bent into a desired configuration. When the entire body 10 is not formed of the same material, the blade portion 12 is preferably formed of a thermoplastic material which affords the indicated flexibility yet retention of set positions. Suitable thermoplastic materials include, without limitation, polyethylene.

The toothpick is characterized by a substantially planar back surface 20 which extends substantially the entire length of the blade portion, the entire length of the handle portion, and at least partially along the length of claw portion.

The blade portion 12, which accounts for greater than half the overall length of the toothpick body 10, is elongate and tapered, with tapering of the blade portion being substantially uniform along its entire length. The blade portion includes opposed lateral surfaces 22, 24 which meet to form an edge 26 that slopes toward the back surface 20 (i.e., from its junction with the handle portion to the end of the blade portion). As shown most clearly in FIG. 3, the back surface 20 also narrows to meet the edge 26, forming a blunt point 28 at the end of the blade portion. Due to the configuration of the lateral surfaces 22, 24 and the back surface 20, the blade portion has a substantially triangular cross-section along substantially its entire length, with the cross-sectional area of the blade portion diminishing from its maximum area adjacent the handle portion to its minimum area at the tip thereof. Cross sectional FIGS. 4A and 4B illustrate the reduction in the cross sectional area along the length of the blade portion.

At the opposite end of the body 10 is the claw portion 14. Like the blade portion, the claw portion, too, is tapered. However, the tapering of the claw portion is non-uniform along the entire length thereof. The claw portion includes an inner arcuate surface 32, an outer arcuate surface 34, and tapered lateral sides 36, 38. The outer arcuate surface 34 is characterized by a radius which is larger than a radius of the inner arcuate surface, thus giving the claw portion is claw-like appearance. The tapered lateral sides 36, 38, because of their non-uniform tapering, meet at approximately the mid-point of the claw portion to form an edge on the inner arcuate surface 32. Where the inner and outer arcuate surfaces meet, a tip 40 is formed.

In between the blade portion 12 and the claw portion 14 is the handle portion 16. The handle portion 16 generally has a box rectangular configuration, with a front surface 42 opposite the back surface 20 thereof, and opposite sides 44, 46 thereof. Each of the opposite sides 44, 46 is non-planar, having shallow depressions which extend substantially the entire length thereof. These shallow depressions of the opposite sides, together reducing the thickness of the handle portion at approximately its midpoint, are adapted to receive the fingers (i.e., thumb and forefinger) of a user.

The toothpick of the present invention can be manufactured according to conventional injection molding or casting procedures. A mold body is filled with one or more thermoplastic materials and, when sufficiently cured, the toothpick is removed from the mold.

In use, an individual will grasp the toothpick along its sides 44, 46 thereof and manipulate the blade portion thereof into the spaces between teeth and along gum lines (thereby stimulating the gums). In hard to reach places, such as in between molars, the blade portion can be bent either during use or by the individual simply grasping the blade portion with their other hand. The blade, remaining set in its new position, will allow the user to manipulate the blade between the molars. Should the user encounter a piece of food lodged stubbornly between teeth, the toothpick can be adjusted (by changing the user's grip) such the claw portion can be manipulated into position to access the lodged piece of food. Because the claw is much less flexible, it can readily remove stubbornly lodged pieces of food which the blade could not remove. Because the handle portion is present between the claw portion and the blade portion, the handle portion affords a user the opportunity to switch the end being employed without having to grip an end of the toothpick which has already been moistened by saliva.

Other embodiments can also be envisioned. For instance, although the handle portion provides a significant advantage, its presence is not required. Therefore, another embodiment of the present invention can include a unitary body including a blade portion at one end of the body and a claw portion at an opposite end of the body, with the blade portion and the claw portion being substantially as described above with respect to the first embodiment. In this arrangement, the blade portion and claw portion simply transition one from the other, without a readily identifiable handle portion.

Although the invention has been described in detail for the purpose of illustration, it is understood that such detail is solely for that purpose, and variations can be made therein by those skilled in the art without departing from the spirit and scope of the invention which is defined by the following claims.

What is claimed:

1. A toothpick comprising:
a unitary body including a blade portion at one end of the body, a claw portion at an opposite end of the body, and a handle portion positioned between the blade portion and the claw portion.

2. The toothpick according to claim 1, wherein the blade portion is elongate and tapered.

3. The toothpick according to claim 2, wherein tapering of the blade portion is substantially uniform along the entire length of the blade portion.

4. The toothpick according to claim 2, wherein the blade portion has a substantially triangular cross-section along substantially its entire length.

5. The toothpick according to claim 1, wherein the blade portion is flexible.

6. The toothpick according to claim 5, wherein the blade portion is flexible between a first position and a second position, and when bent into the second position the blade portion remains substantially set in the second position.

7. The toothpick according to claim 1, wherein the blade portion is formed of a thermoplastic material.

8. The toothpick according to claim 7, wherein the thermoplastic material is polyethylene.

9. The toothpick according to claim 1, wherein the toothpick is formed of a thermoplastic material.

10. The toothpick according to claim 9, wherein the thermoplastic material is polyethylene.

11. The toothpick according to claim 1, wherein the claw portion is tapered.

12. The toothpick according to claim 11, wherein tapering of the claw portion is non-uniform along the entire length of the claw portion.

13. The toothpick according to claim 11, wherein the claw portion comprises an inner arcuate surface, an outer arcuate surface, and tapered lateral sides.

14. The toothpick according to claim 11, wherein the outer arcuate surface is characterized by a radius which is larger than a radius of the inner arcuate surface.

15. The toothpick according to claim 1, wherein the toothpick comprises a planar surface extending substantially the entire length of the blade portion, the entire length of the handle portion, and at least partially along the length of claw portion.

16. The toothpick according to claim 15, the handle portion including opposite sides thereof adjacent the back surface, the opposite sides including shallow depressions which extend substantially the entire length thereof.

17. A toothpick comprising:
a unitary body formed of a thermoplastic material, the body including a blade portion at one end of the body, a claw portion at an opposite end of the body, and a handle portion positioned between the blade portion and the claw portion,
wherein the blade portion is elongate and tapered uniformly along substantially the entire length thereof and is sufficiently flexible for bending between a first position and a second position, yet when bent into the second position the blade portion remains substantially set in the second position.

18. A toothpick comprising:
a unitary body formed of a thermoplastic material, the body including:
(i) a blade portion at one end of the body, the blade portion being elongate and tapered uniformly along substantially the entire length thereof, having a substantially triangular cross-section along substantially the entire length thereof, and being sufficiently flexible for bending between a first position and a second position, yet when bent into the second position the blade portion remains substantially set in the second position;
(ii) a claw portion at an opposite end of the body, the claw portion including an inner arcuate surface, an outer arcuate surface, and tapered lateral sides, where the outer arcuate surface is characterized by a radius which is larger than a radius of the inner arcuate surface; and
(iii) a handle portion positioned between the blade portion and the claw portion, the handle portion having opposite sides including shallow depressions which extend substantially the entire length thereof.
